(19) United States
(12) Patent Application Publication
(10) Pub. No.: US 2022/0290767 A1
(43) Pub. Date: Sep. 15, 2022

(54) NON-RETURN CHECK VALVE FOR VACUUM SYSTEM

(71) Applicant: Edwards Limited, Burgess Hill, West Sussex (GB)

(72) Inventors: David Alan Turrell, Burgess Hill, Sussex (GB); Phillip North, Burgess Hill, Sussex (GB); Neil Turner, Burgess Hill, Sussex (GB); Michael Henry North, Burgess Hill, Sussex (GB); Clifford George Burt, Burgess Hill, Sussex (GB); Sivabalan Kailasam, Burgess Hill, Sussex (GB); Cainan Long, Burgess Hill, Sussex (GB); Ian David Stones, Burgess Hill, Sussex (GB)

(21) Appl. No.: 17/634,643

(22) PCT Filed: Aug. 13, 2020
(86) PCT No.: PCT/GB2020/051924

§ 371 Date: Feb. 11, 2022

(30) Foreign Application Priority Data
Aug. 13, 2019 (GB) 1911584.9

(51) Int. Cl. F16K 15/06; F16K 15/04; F16K 25/00; F16K 27/00

(52) U.S. Cl. CPC F16K 15/063; F16K 15/04; F16K 25/005; F16K 27/003

(57) ABSTRACT

A vacuum system non-return valve has a baffle for extending across a flow path The baffle has an aperture, a perimeter of the aperture having a valve seat. The valve also has a valve member having a protrusion extending from a surface configured to mate with the valve seat, the protrusion extending through the aperture; wherein the protrusion includes a retaining portion extending outwardly from the protrusion and configured such that the retaining portion cannot pass through the aperture. The valve member and aperture are configured such that the valve member obscures the aperture and seals with the valve seat to impede a flow of fluid from an outlet end to an inlet end in a closed position and is displaceable in use to move away from the valve seat and allow a fluid flow from the inlet end to the outlet end in an open position.

### CROSS-REFERENCE OF RELATED APPLICATION

This application is a Section 371 National Stage Application of International Application No. PCT/GB2020/051924, filed Aug. 13, 2020, and published as WO 2021/028687 A1 on Feb. 18, 2021, the content of which is hereby incorporated by reference in its entirety and which claims priority of British Application No. 1911584.9, filed Aug. 13, 2019.

### FIELD

The field of the invention relates to non-return valves for use in vacuum systems.

### BACKGROUND

Non-return valves are used in vacuum systems to allow fluid to be pumped in one direction and to resist the return of the fluid from a higher pressure region to the vacuum region. They are used for example as internal pressure relief valves such as blow-off valves, or as exhaust check valves in dry pumps, or as non-return valves in abatement systems.

The pressure differences found within vacuum systems can be high and these require effective seals. Additionally the process gases being pumped in many vacuum systems are corrosive gases at high temperatures. These gases limit the number of sealing materials that are suitable for seals in such systems, as well as the lifetime of these seals.

It would be desirable to provide an improved non-return valve that has improved resistance to corrosive and hot process gases.

The discussion above is merely provided for general background information and is not intended to be used as an aid in determining the scope of the claimed subject matter. The claimed subject matter is not limited to implementations that solve any or all disadvantages noted in the background.

### SUMMARY

A first aspect provides a vacuum system non-return valve comprising: a baffle for extending across a flow path in said vacuum system, said baffle comprising an aperture, a perimeter of said aperture comprising a valve seat; a valve member comprising a protrusion extending from a surface configured to mate with said valve seat, said protrusion extending through said aperture; wherein said protrusion comprises a retaining portion extending outwardly from said protrusion and configured such that said retaining portion cannot pass through said aperture; said valve member and aperture being configured such that said valve member obscures said aperture and seals with said valve seat to impede a flow of fluid from an outlet end to an inlet end in a closed position and is displaceable in use to move away from said valve seat and allow a fluid flow from said inlet end to said outlet end in an open position; said retaining portion being configured to limit the travel of the valve member towards said outlet end when said valve is in said open position.

The inventors of the present invention recognised that sealing within the environments of many vacuum systems is both challenging and expensive. In particular, many conventional sealing materials such as elastomeric materials are degraded at high temperatures and by corrosive gases. Such high temperature corrosive environments are often the environments found in vacuum systems. Non-return valves conventionally have a valve member or body which is free to move between an open and closed position. Conventionally such valves have been formed in two pieces with a seal between the two pieces to allow the valve body to be inserted and retained within the valve.

The inventors of the present invention recognised that although seals are required between the valve and the vacuum system, any additional seals in the outer envelope of the valve might be avoided. With this in mind, they have provided a valve with a simple configuration such that the valve member is retained by an element extending through the aperture, allowing the check valve to be formed of fewer parts and with correspondingly fewer sealing requirements.

In some embodiments, said outer envelope consists of an outer perimeter of said baffle.

Although, in some cases the outer envelope of the valve runs as an annular member from the inlet to the outlet and provides a space that contains the baffle (having the aperture) and also the movable valve member, in some cases the outer envelope is only the outer diameter of the baffle and in such a case, the valve member will move within the vacuum assembly to which the baffle is attached. Such an arrangement reduces the number of seals required to attach the valve to the valve assembly and also makes for a very compact valve. However, in this case the valve assembly should be designed such that the portion to which the baffle is attached is such that the valve member has space to move within it, so that the valve member can move between an open position where it is not in contact with the baffle and aperture and a closed position in which it seals with the baffle and closes the aperture.

In some embodiments, said outer envelope of said valve is configured to support a seal for sealing with said vacuum system.

Where the baffle member's outer perimeter forms the outer envelope of the valve, then this outer perimeter may be configured to hold a seal perhaps an O ring such that it can be sealed to the vacuum assembly and held fast in a convenient manner.

In some embodiments, said non-return valve further comprises: an outer envelope configured to sealingly mate with said vacuum system, said outer envelope being formed as a single piece and comprising an inlet end and an outlet end, said inlet and outlet ends being in fluid communication via said aperture, said aperture defining a through passage through said valve

Having a single outer envelope reduces the number of seals required to attach the check valve to the vacuum system.

In some embodiments, said outer envelope comprises an annular wall connecting said inlet and outlet ends.

The valve provides a flow passage between an inlet and outlet that can be opened or obscured by the valve member. This flow passage is provided in some embodiments by the outer envelope comprising an annular wall with the fluid flowing through the inner space surrounded by the wall.

In some embodiments, said outer envelope comprises a substantially cylindrical shape.

In other embodiments, said outer envelope has a cross section that increases towards a central portion.

A practical shape may be a cylinder which is robust easy to manufacture and which can contain the valve member and provide a fluid flow passage. Where the valve member is configured to obstruct the fluid flow path and where a sizeable aperture is used to improve fluid conductance then an equally sizeable valve member is required. In such a case it may be advantageous to increase the diameter of the valve towards a central portion where the aperture and valve member are located. This provides additional space for the fluid to flow around the valve member when in the open position and improves conductance.

In some embodiments, said inlet and outlet end comprise flanges extending outwardly from said annular wall for mating with conduits of said vacuum system.

The outer envelope may comprise flanges at either end for attaching to the vacuum system by clamping means.

In some embodiments, said outer envelope comprises a central portion which extends out to an outer diameter of said flanges.

As noted previously, it may be advantageous to increase the diameter of the outer envelope towards the central portion. It may also be advantageous to have flanges at either end to attach the valve to the vacuum system. Increasing the middle diameter by an amount that renders the diameter towards the middle a similar size to the diameter of the flanges allows the valve to be provided with an increased conductance but with a diameter that does not exceed the maximum diameter governed by the size of the flanges.

In some embodiments, said valve seat comprises an elastomeric material.

The inventors recognised that an elastomeric material makes an effective sealing material but is vulnerable at high temperatures and to some corrosive environments. They realised that providing such a material on the valve seat rather than the valve member allowed the material to be kept at a more controlled temperature, as the material would be in contact with the housing at all times.

As the valve body is within the gas flow and remote from the housing for much of its operation, where the gas flow is a hot gas flow then the valve member will heat up and unless made of particularly temperature resistant material may be damaged

Furthermore, for many valve members, the contacting surface between the valve member and the valve seat, may be anywhere on the entire outer surface, so that providing the sealing material on the valve seat allows a reduced amount of sealing material to be used.

In some embodiments, said elastomeric material comprises a coating around a periphery of said aperture at said outlet end.

Elastomeric material may be used to provide an effective seal between the valve member and the valve seat. Where the elastomeric material is mounted on the valve seat, this should cover an area that the valve member will contact. In some cases, this is around the periphery of the aperture at the outlet end of the aperture. Alternatively, the elastomeric material can be an annular insert attached to the aperture again providing a covering around the periphery of the aperture at the outlet end. In this case being a separate elastomeric insert that can be mounted to the aperture is used.

In some embodiments, said surface from which said protrusion extends comprises a curved surface.

Although, the lower surface of the valve member which seals with the valve seat may have a number of forms, it may be advantageous for it to be curved perhaps hemi-spherical in shape, as such a form will seal well with an aperture and will also seal with the valve member in slightly different orientations. This can help impede the build-up of sediment from the process gasses on the valve member.

In some embodiments, said retaining portion has a length that is larger than a diameter of said aperture.

In order to prevent the retaining portion from passing through the aperture it may be that at least one dimension of the retaining portion that is perpendicular to the protrusion is longer than the diameter of the aperture.

In some embodiments, said valve member is formed of a ceramic material, while in other embodiments said valve member is formed of a metal such as stainless steel.

Both ceramic materials and metals such as stainless steel are resistant to high temperatures and resistant to many corrosive materials. Furthermore, where the valve seat has an elastomeric material then such relatively hard bodies form an effective seal with the elastomeric material on the valve seat.

Other materials that themselves form an effective seal may be used for the valve member, particularly where the valve is to be used in an environment that is not particularly hot and/or does not transmit corrosive gases.

In some embodiments, said valve member comprises a curved sealing surface configured to mate with said valve seat; and at least a portion of said surface of said baffle surrounding said aperture is sloped towards said inlet end of said valve such that said aperture is larger towards said outlet end than towards said inlet.

The inventors of the present invention recognised that where compressible elastomer type materials were not available for sealing it is particularly important that the sealing surfaces have a good contact if the seal is to be effective. Furthermore, if the valve is to be displaced continually its orientation may change slightly each time it is displaced and thus, it is also advantageous if the available sealing surface is not localised to a particular orientation. A valve member with a curved surface and a sloped valve seat provides an effective sealing surface and allows the valve member to seal effectively with the valve member in different orientations.

In some embodiments, diametrically opposing portions of said sloped surfaces of said aperture subtend an angle of between 45° and 100°, preferably said apertures subtends an angle of between 55° and 70°.

It has been found that a sloped surface around the aperture of the valve can provide an effective seal with the curved surface of the valve member and in particular angles of between 45° and 100° more preferably 55° and 70° have been found to receive the valve member securely, robustly and provide effective sealing.

In some embodiments, the diameter of the valve member is between 5 and 10% larger than the diameter of the valve seat and the angle subtended by the sloped surface is between 55° and 70°.

The angle of the slope, and relative sizes of the aperture and valve member are selected so that the slope of the surface at the valve seat is tangential to the curved surface of the valve member at the desired mating position. In this regard where they are selected to be similar in size, then the valve member mates with the valve seat at a point closest to the widest part of the valve member where the slope of the valve member surface is steep, and in such a case the appropriate angle is a smaller angle. Having the valve member of a similar but slightly larger diameter than the valve seat provides for effective sealing without unduly obscuring the channel when in the open position.

In other embodiments, the diameter of the valve member is between 15 and 30% larger than the diameter of the valve seat and the angle subtended by the sloped surface is between 75° and 95°.

In some cases it may be advantageous for the valve member to contact the aperture at a point away from its widest point where a tangent to the curved surface is less steep. This may provide an effective sealing surface, but the increased size of the valve member relative to the aperture may lead to increased impeding of the fluid flow in the open position.

In some embodiments, said sloped portion of said surface surrounding said aperture extends from a surface facing said outlet end of said valve towards said surface facing said inlet end and becomes steeper for a portion extending to said surface facing said inlet end, said valve seat being at a location at or close to a change in said angle of slope.

In some embodiments, the angle of the slope becomes steeper towards the inlet end and this allows the location of the valve seat to be close to the area where it becomes steeper and away from the edge of the aperture of the inlet side. This makes for a more robust valve seat where the valve seat portion that is supporting the valve member is not close to the edge of the aperture.

In other embodiments, said sloped surface comprises a curved profile configured to substantially match a curved profile of said valve member.

An alternative configuration is where the sloped surface has a curved profile, the curved profile matching the curved profile of the valve member. Although, this may provide additional sealing area as the contact area may be across a wider area, it does require matching of the curved surfaces to provide such effective sealing.

In some embodiments, said surface of said baffle surrounding said aperture comprises an indent such that said valve member is configured to contact said surface surrounding said aperture at two places at either end of said indent.

An alternative embodiment provides an indent in the sloped surface of the aperture and this indent provides an area that does not contact the curved surface of the valve member such that the valve member contacts the valve seat at two positions on either side of the indent. This can be particularly effective at sealing in effect providing two sealing locations.

In some embodiments, said valve member is solid, while in other embodiments said valve member is hollow. The valve member may be formed of a number of materials and may be hollow or solid and is generally configured to have a certain mass, the mass being selected to provide appropriate protection against reverse flow of gasses while not being too large such that it creates a significant back pressure on the vacuum system.

A second aspect provides a vacuum system non-return valve comprising: a baffle for extending across a flow path in said vacuum system, said baffle comprising an aperture, a perimeter of said aperture comprising a valve seat; a valve member comprising a curved sealing surface configured to mate with said valve seat, said valve member and aperture being configured such that said valve member obscures said aperture and seals with said valve seat to impede a flow of fluid from an outlet end to an inlet end in a closed position and is displaceable in use to move away from said valve seat and allow a fluid flow from said inlet end to said outlet end in an open position; at least a portion of said surface of said baffle surrounding said aperture slopes inwardly towards said inlet end of said valve such that said aperture is smaller at said inlet end than it is at said outlet end.

The sloped surface of the valve seat around the aperture in a baffle configured to mate with a curved surface is also applicable to check valves other than those with a protrusion extending through the aperture and a retaining member attached thereto. In particular, where compressible elastomer type materials are not available for sealing it is particularly important that the sealing surfaces have a good contact if the seal is to be effective. A valve with a curved surface and a sloped valve seat provides an effective sealing surface and allows the valve member to seal effectively with the valve member in different orientations.

The sloped surface around the aperture, may be angled as described above or may be curved or have an indent. In this aspect the valve member may comprise a protrusion comprising a retaining means as for the first aspect or there may be some other means for retaining the valve member within the check valve such as a grid or cage retaining member.

A third aspect provides a vacuum system non-return valve apparatus comprising two vacuum system non return valves according to a first or second aspect arranged in series with respect to each other, such that fluid from an inlet end of said valve apparatus flows through a first of said non return valves and then through a second of said non return valves.

The non return valves of embodiments may be used as a double check valve to provide additional protection against backflow. A check valve provides a possible leakage path for gas from the higher pressure outside of the vacuum system into the vacuum system. This can be particularly problematic for valves where conventional elastomer sealing means are not used due to the harsh conditions experienced. The leakage rate depends on the pressure differential across the valve. Providing the check valve as a double check valve provides an intermediate volume between the two check valves that will be at an intermediate pressure, such that the pressure drop across each valve is smaller than it would be across a single valve. This results in a lower leakage rate for each of the check valves when the system is operating in normal operational mode and the valves are closed than would be the case if a single valve were used.

In some embodiments, the system further comprises an intermediate volume providing a flow path between said two valve seats, a length of said flow path being between 1.5 and 10 times a diameter of said valve seats, preferably between 1.5 and 6 times.

In order for the double check valve to be particularly effective there should be a volume between the two valves such that the pressure differential between the vacuum system and the outside is split across the two check valves. The smaller the intermediate volume the quicker the intermediate pressure reaches an equilibrium steady state value when the valves close, however, the volume should be sufficient to allow each valve to open and close without physically impacting the other valve.

In some embodiments, said intermediate volume is within a pipe connecting said first and second intermediate valves.

In some embodiments, the two check valves may be independent units and may be connected by a connecting pipe. The length of the connecting pipe is selected to provide a suitable intermediate volume. In some cases, the length of the pipe between the two valve seats of the two valves is between 1.5 and 10 times the diameter of the valve seat.

In other embodiments, the apparatus comprises a combined outer housing for housing both said first and second check valves.

It may be advantageous for the double check valve to be formed in a single housing which may be attached to the apparatus thereby requiring fewer sealing means. As has been noted before in corrosive and hot environments sealing means deteriorate and thus, reducing the requirement for sealing means is advantageous.

In some embodiments, said combined outer housing is configured such that a flow path between said check valves comprises a portion running in an opposite direction to a flow path in and out of said valve apparatus.

The combined housing may be configured such that the two check valves are arranged in effect side by side such that the flow path between them changes direction as it goes out of one valve and back down towards the second valve. The direction of the gas flow in and gas flow out may be a single direction the direction of flow simply changing as it passes between the valves in the check valve.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention will now be described further, with reference to the accompanying drawings, in which:

FIG. 1 shows a valve according to an embodiment, where the valve body comprises the retaining means;

FIG. 2 shows a reduced height valve according to a still further embodiment;

FIG. 3 schematically shows a non-return check valve according to an embodiment;

FIG. 4 schematically shows a non-return check valve according to a further embodiment;

FIG. 5 schematically shows a non-return check valve according to a still further embodiment;

FIG. 6 shows a double check valve according to an embodiment; and

FIG. 7 shows an alternative embodiment of a double check valve.

### DETAILED DESCRIPTION

Before discussing the embodiments in any more detail, first an overview will be provided.

Embodiments seek to provide a non-return valve such as a dry-pump exhaust check-valve without a static seal in the housing, by making the outer housing in one piece. Eliminating the seal (which is normally an elastomer) allows the check-valve to be used at high temperatures without worrying about the life of the internal seal. The external seal (to the vacuum system pipe-work) still needs thinking about, but that is typically somewhat easier to deal with, having in many cases a larger cross-section.

In this regard, various problems with materials in pump check-valves mean that it is desirable to eliminate or at least reduce the occurrence of elastomers and polymer materials from the design where possible. There is scope for changing the internal parts and compromising some sealing quality and still have a good enough check-valve. The one place where sealing can't be compromised is between the inside and outside of the valve body, i.e. at the flanges connecting to the vacuum system and at the split which is between the two parts of the body which are conventionally assembled around the moving part to ensure that it cannot be lost outside of the valve body. There will always be a seal at the flange between the check-valve and the vacuum assembly exhaust pipe, but making the body in one piece and arranging a method of retention for the moving part that does not require the body to be taken apart can eliminate the need for a body seal.

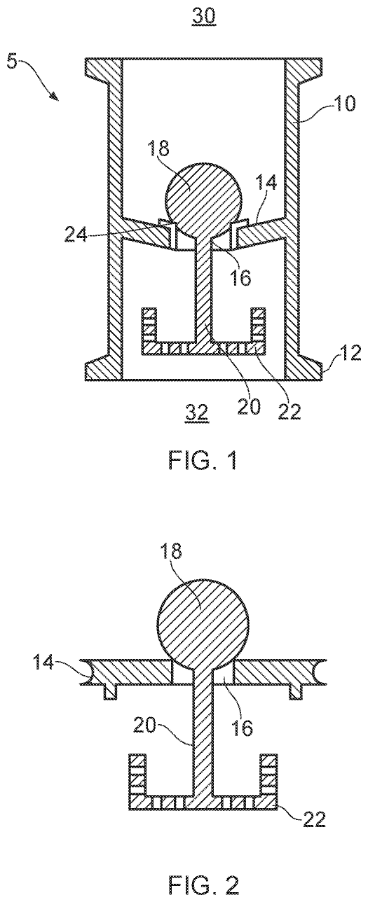

FIG. 1 shows a valve 5 according to an embodiment. The valve 5 comprises a one piece outer housing 10, comprising an annular body formed of a substantially cylindrical tube that forms a flow path from an inlet 32 to an outlet 30. The cylindrical tube comprises flanges 12 at either end and an integral baffle 14 across the middle. The only seals in this system are those required to attach the valve to the vacuum system at the end flanges 12, and these will be of standard design for such flanges.

The baffle 14 has sloping walls whose upper surface slope down towards aperture 16. Aperture 16 is sealed by the ball 18 under the action of gravity. There is a retaining device 20, 22 for retaining the ball 18 close to the aperture 16. Retaining device 20, 22 comprises a protrusion or stick 20 extending from a lower surface of the sphere or ball 18 and a retaining part 22 extending outwardly from stick 20. The retaining part 22 is configured to be too big to fit through the hole 16 in the baffle 14 and limits the travel of the ball 18 towards the outlet 30. The retaining part 22 is perforated so that it does not block the hole in the baffle at the limit of travel. The stick 20 could be threaded and screwed into the ball 18 possibly with a slightly mis-matched thread pitch or glue to stop it coming undone.

Although in this embodiment the valve body 18 comprises a ball, it may in other embodiments, comprise other forms. The ball 18 has an advantage over a flat “puck” in that it will rotate to present different areas of its surface to the seat. Some “puck” style valves accumulate process material on the face where the gas impinges. Even though the stick limits the range of movement, the retained ball can still land in different orientations, and will shed process accumulation better.

It should be noted that only the lower surface of the body 18 needs to be present. If the density of the “ball” material is high, which would otherwise give a too high lifting pressure for the valve, then the top part of the “ball” can be re-shaped, omitted, hollowed out, etc. In an embodiment where the baffle floor is sloped to help centre the valve body 18, then it is advantageous if the lower surface of the body is curved. In other embodiments, a flat lower surface would be acceptable, in such embodiments it is preferable if the upper surface of baffle 14 is also flat. In other embodiments, a conical type lower surface configured to match with a conical shaped baffle upper surface may also be used.

In this embodiment there is an optional softer sealing material 24 such as an elastomer arranged at the sealing surface or valve seat of the aperture 16, which material improves the seal. Because such material is attached to the housing which is conventionally a metal body, it is likely to stay at a lower temperature than the same material were it located on the moving ball suspended in the hot gas stream for much of the time, with no thermal path to the outside world. Furthermore, a reduced quantity of sealing material may be required for a seal arranged in this way.

In this embodiment the outer walls comprise a cylindrical housing. However, embodiments are not limited to this and in other embodiments, the annular housing may bulge radially outwards in the middle between the flanges such that the central portion has a larger diameter than the upper and lower portion. This is done to increase fluid conductance, a larger diameter providing additional space around the valve member when it is in an open position and also in some embodiments allowing an increased sized aperture.

In some embodiments, the increase in diameter of the central portion may be restricted to an increase that extends out as far as the outer diameter of the flanges 12. In this regard the diameter of the housing may be lower immediately adjacent to the flanges to allow the flanges to be clamped, and it may then extend out towards the middle portion as far as the outer diameter of the flanges. This increases the conductance of the valve, while not unduly increasing its size.

FIG. 2 shows a further embodiment, where the valve outer housing 10 has been shrunk to the point that it extends only for the width of the baffle 14. The hole 16 and baffle 14 thus, form the centre of a centring-ring seal carrier. The function is as in FIG. 1, except that the role of the outer housing is provided by the pipeline into which the valve is inserted. Some poka-yoke features can be used to ensure that the valve is always inserted the right way up. It should be noted that in this embodiment, the adjoining pieces of pipeline need to include enough space to allow the ball to move. This embodiment provides a reduced space solution where a single seal is required to attach the valve to the vacuum assembly, the single seal being mounted around the outer perimeter of baffle 14. Thus, in this embodiment a further seal is eliminated. This reduces still further the costs of the seals and the risk of a seal leaking. This reduction in cost is particularly advantageous where the vacuum environment and process gases being pumped is one where expensive elastomers such as FFKM elastomers are required for effective and long life seals.

It should be noted that although the elastomer insert 24 is only shown in the embodiment of FIG. 1, it may also be used in the embodiment of FIG. 2. Using an elastomer on the valve seat allows the valve member 18 to be formed of a harder material, such as stainless steel or a ceramic. These harder materials are generally more resistant to high temperatures and to the corrosive nature of some process gases. In some embodiments where there is no elastomer coating or insert 24 on the valve seat of aperture 16, then the valve body 18 may be formed with an elastomer coating, or of a PTFE material.

Although the valve body is generally shown as a sphere or ball, it may also take the form of a puck dimensioned to obscure the aperture 16. In such a case, the baffle 14 will have a flat upper surface.

In the embodiments of FIGS. 1 and 2 the valve body element 18 may have the form of a partial sphere, so that the lower surface is curved or spherical and the upper surface may have another form. In this regard the form may be selected dependent on the optimal mass for the body and on the desired size of the valve.

In some embodiments, the valve is arranged such that it is disposed vertically when in operation so that the valve body seals with the aperture due to gravity when there is no fluid flow. Flow from the inlet dislodges the valve body 18 and opens the aperture 16 allowing gas to flow through the valve. When attached to the vacuum system where the pipes are not vertically arranged, elbow pipes may be used to turn the flow direction prior to entry or exit from the valve. In other embodiments there may be some other means to bias the valve to a closed position such as a spring. The latter may be less preferable adding an additional component that may be subject to wear and reliability issues, particularly when the check valve is to be used in harsh and hot environments.

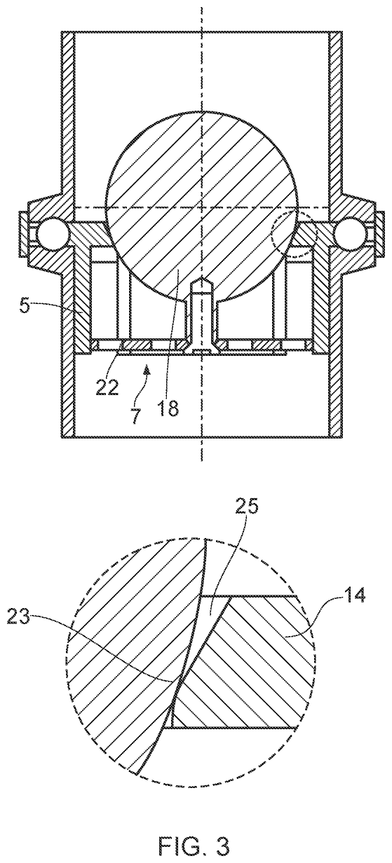

FIG. 3 shows a section through a check valve 5 according to a further embodiment. Check valve 5 comprises a valve member 18 in the form of a ball and from which there extends a protrusion and retaining member 22. The retaining member is perforated to allow gas to pass through it. The valve member 18 mates with a valve seat 22 formed in a baffle 14 which extends across the pipe in which the valve is mounted and which comprises an aperture having a sloped surface 25 of a first angle and a more steeply sloped surface. The valve seat 22 is located close to the change in angle of the slopes and is shown in more detail in the lower figure which relates to enlarged portion D. This arrangement of a sloped surface angled to match the curved surface of the valve member 18 provides effective sealing even where both valve seat and valve member are formed of hard materials such as metals.

The check valve 5 is mounted via seals within a pipe and gas flows in the direction of arrow 7 from a vacuum exhaust system towards an outlet. When the pressure in the vacuum system rises a force is exerted on valve member 18 which is pushed off valve seat 23 into an open position in which position gas can flow through the aperture which is no longer obscured by valve member 18 and out through the top of the pipe. When the pressure within the system falls then the valve body 18 will return to the aperture under its weight and will seal with valve seat 23 such that gas at a higher pressure outside of the vacuum system may not enter the vacuum system.

The aperture in baffle 14 has a sloped surface 25 adjacent to the outlet which subtends an angle of 60° with a sloped surface on the diametrically opposing side of the aperture and this provides a suitable slope for mating with the curved surface of the ball and providing a good seal. The slope becomes steeper towards the inlet of the valve such that the position of the valve seat is well defined and not towards one end of the sloping surface allowing the ball to be held securely and the valve seat not to be easily damaged.

The angle of 60° has been found to be particularly effective for valve members where the diameter of the ball is close to the diameter of the valve seat. In this regard, the diameter of the ball is between 5 and 18% larger than the diameter of the aperture preferably between 5 and 10% larger.

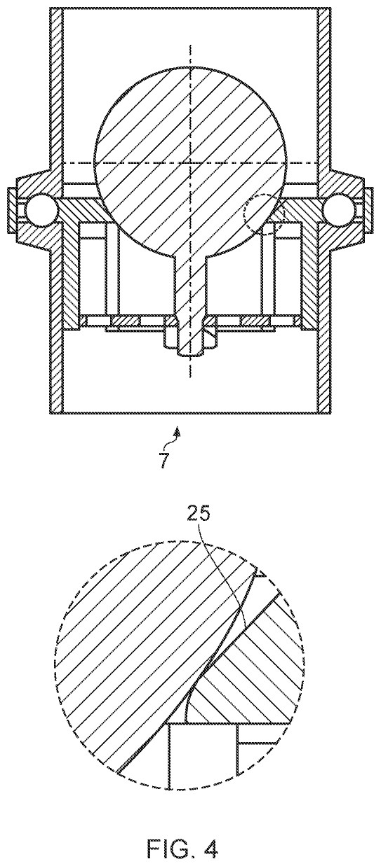

FIG. 4 shows an alternative embodiment where the angle of the sloping surface 25 is a less steep angle and in this embodiment subtends an angle of 90° with the sloping surface on the diametrically opposed side of the aperture. As in the previous embodiment the slope gets steeper towards the inlet such that the valve seat is in a defined place on the surface. In this embodiment, the diameter of the valve member and the diameter of the seat are more different such that the valve member is held at a position that is not close to the middle of the valve member and thus, the sloping angle of the curved surface is greater and matches the slope of the valve seat. In this embodiment, the diameter of the ball is between 15 and 30% larger than the diameter of the valve seat. The lower figure shows an enlarged portion of section F of the upper figure.

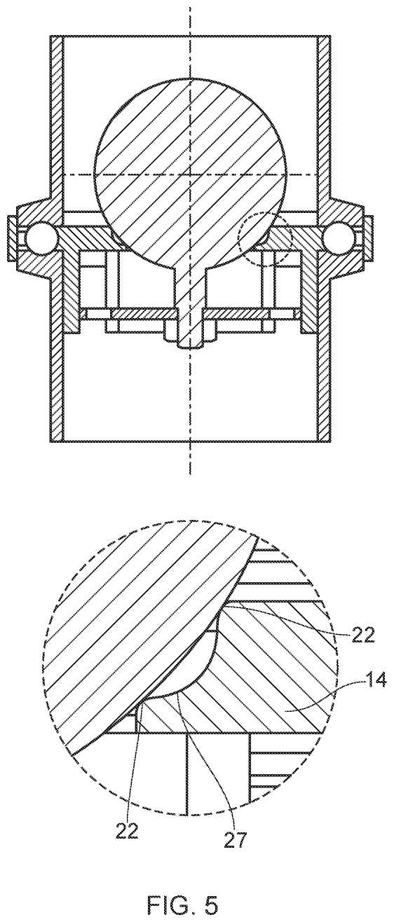

FIG. 5 shows another embodiment where the profile of the surface of the aperture that forms the valve seat has an indent 27 within it such that two valve seats 22 are formed on either side of the indent. The inlet side of the aperture is smaller than the outlet side such that the valve member is held at both points and an effective seal is made at two points leading to better sealing. The lower figure shows an enlarged portion of section J of the upper figure.

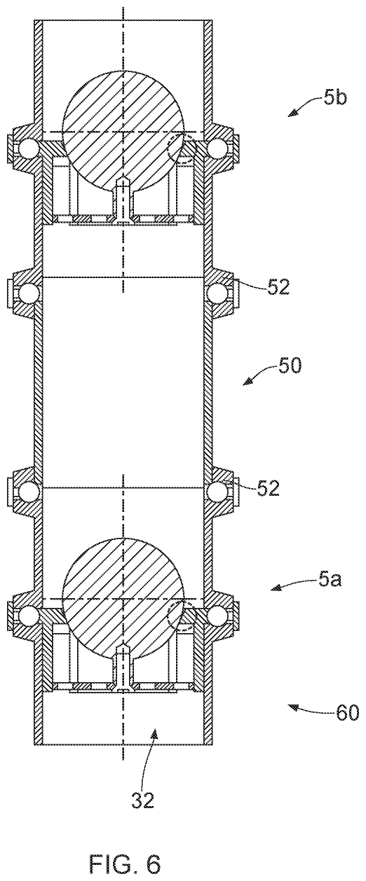

FIG. 6 shows a further embodiment where a double check valve 60 is provided using two check valves 5a and 5b of the previous embodiments. The two check valves form a double check valve and gas enters via inlet 32. When the pressure at the inlet 32 is low, there is more effective sealing between the vacuum system and the outside compared to a single valve. The intermediate volume within pipe 50 is at an intermediate pressure when the two valves are closed such that the pressure drop between the inlet 32 and outside is split across each of the different check valves which reduces the back leakage during normal operation. In this regard the leakage across each valve is dependent upon the pressure drop across the valve, thus, reducing the pressure drop by splitting it between two valves reduces the leakage. The intermediate volume should be selected to be sufficient for the two valves not to physically impact each other during operation, but preferably not significantly larger than this. A larger intermediate volume increases the time for the intermediate volume to reach an equilibrium intermediate pressure when the double check valve closes and this impacts on the vacuum system that the check valve is attached to.

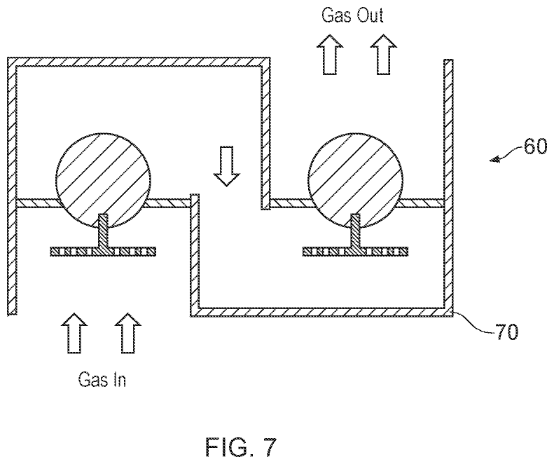

FIG. 7 shows an alternative embodiment where double check valve 60 is mounted within a single housing 70. Having a single housing makes a valve easier to mount to a system and also reduces the number of seals required to seal it to the system. As has been noted earlier, seals to high temperature corrosive systems can be problematic and reducing the number that is required can be advantageous.

This embodiment provides a particularly compact check valve that can fit into a small space. The two check valves are mounted side by side and this requires the gas flow to change direction as it travels through the valve.

Although the double check valve is shown with a valve member comprising a protrusion and retaining member 22, it may be used with a curved valve member and some other retaining means such as a grid or cage between the valve member and the outlet.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A vacuum system non-return valve comprising:
a baffle for extending across a flow path in said vacuum system, said baffle comprising an aperture, a perimeter of said aperture comprising a valve seat;
a valve member comprising a protrusion extending from a surface configured to mate with said valve seat, said protrusion extending through said aperture; wherein
said protrusion comprises a retaining portion extending outwardly from said protrusion and configured such that said retaining portion cannot pass through said aperture;
said valve member and aperture being configured such that said valve member obscures said aperture and seals with said valve seat to impede a flow of fluid from an outlet end to an inlet end in a closed position and is displaceable in use to move away from said valve seat and allow a fluid flow from said inlet end to said outlet end in an open position;
said retaining portion being configured to limit the travel of the valve member towards said outlet end when said valve is in said open position.

2. The vacuum system non-return valve according to claim 1, said baffle comprising an outer perimeter configured to seal with said vacuum system.

3. The vacuum system non-return valve according to claim 1 and further comprising:
an outer envelope configured to sealingly mate with said vacuum system, said outer envelope being formed as a single piece and comprising an inlet end and an outlet end, said inlet and outlet ends being in fluid communication via said aperture, said aperture defining a through passage through said valve.

4. The vacuum system non-return valve according to claim 3, wherein said outer envelope comprises an annular wall connecting said inlet and outlet ends.

5. The vacuum system non-return valve according to claim 4, wherein said outer envelope comprises a substantially cylindrical shape

6. The vacuum system non-return valve according to claim 4, wherein said outer envelope has a cross section that increases towards a central portion.

7. The vacuum system non-return valve according to claim 1, wherein said valve seat comprises an elastomeric material.

8. The vacuum system non-return valve according to claim 1, wherein said surface from which said protrusion extends comprises a curved surface.

9. The vacuum system non-return valve according to claim 1, wherein said valve member comprises a curved sealing surface configured to mate with said valve seat; and
at least a portion of said surface of said baffle surrounding said aperture is sloped towards said inlet end of said valve such that said aperture is larger towards said outlet end than towards said inlet

10. The vacuum system non-return valve according to claim 9, wherein diametrically opposing portions of said sloped surfaces subtend an angle of between 45° and 100°, preferably between 55° and 70°.

11. The vacuum system non-return valve according to claim 9 or 10, wherein said sloped portion of said surface surrounding said aperture extends from a surface facing said outlet end of said valve towards said surface facing said inlet end and becomes steeper for a portion extending to said surface facing said inlet end, said valve seat being at a location at or close to a change in said angle of slope.

12. The vacuum system non-return valve according to claim 9, wherein said sloped surface comprises a curved profile configured to substantially match a curved profile of said valve member.

13. The vacuum system non-return valve according to claim 9, wherein said surface of said baffle surrounding said aperture comprises an indent such that said valve member is configured to contact said surface surrounding said aperture at two places at either end of said indent.

14. The vacuum system non-return valve apparatus comprising two vacuum, system non-return valves according to claim 1, arranged in series with respect to each other, such that fluid from an inlet end of said valve apparatus flows through a first of said non-return valves and then through a second of said non-return valves.

15. The vacuum system non-return valve apparatus according to claim 14, further comprising an intermediate volume providing a flow path between said valve seats of said two valves, said flow path having a length of between 1.5 and 10 times a length of a diameter of said valve seats.

16. The vacuum system non-return valve apparatus according to claim 14, said intermediate volume being within a pipe connecting said first and second intermediate valves.

17. The vacuum system non-return valve apparatus according to claim 14, comprising a combined outer housing for housing both said first and second check valves.

18. The vacuum system non-return valve apparatus according to claim 17, wherein said combined outer housing is configured such that a flow path between said check valves comprises a portion running in an opposite direction to a flow path in and out of said valve apparatus.

19. A vacuum system non-return valve comprising:
a baffle for extending across a flow path in said vacuum system, said baffle comprising an aperture, a perimeter of said aperture comprising a valve seat;
a valve member comprising a curved sealing surface configured to mate with said valve seat, said valve member and aperture being configured such that said valve member obscures said aperture and seals with said valve seat to impede a flow of fluid from an outlet end to an inlet end in a closed position and is displaceable in use to move away from said valve seat and allow a fluid flow from said inlet end to said outlet end in an open position;
at least a portion of said surface of said baffle surrounding said aperture slopes inwardly towards said inlet end of said valve such that said aperture is smaller at said inlet end than it is at said outlet end.
